(19) United States
(12) Patent Application Publication
(10) Pub. No.: US 2025/0027256 A1
(43) Pub. Date: Jan. 23, 2025

(54) METHOD AND APPARATUS FOR DISINFECTANT TEXTILES AND MAINTAINING INCREASED OXIDATION REDUCTION POTENTIAL LEVELS

(71) Applicant: Gurtler Industries, Inc., South Holland, IL (US)

(72) Inventor: Andrew Rupnow, Wisconsin Dells, WI (US)

(73) Assignee: Gurtler Industries, Inc., South Holland, IL (US)

(21) Appl. No.: 18/773,797

(22) Filed: Jul. 16, 2024

Related U.S. Application Data
(60) Provisional application No. 63/515,040, filed on Jul. 21, 2023.

(51) Int. Cl. D06F 39/08; C02F 1/32; C02F 1/72; C02F 1/78; C02F 103/00

(52) U.S. Cl. CPC D06F 39/083; C02F 1/32; C02F 1/722; C02F 1/78; C02F 2103/002; C02F 2201/782; C02F 2303/04

(57) ABSTRACT

Processes and apparatus for disinfecting textiles with a tunnel washing system having: a housing including a main wash zone, and a rinse zone, the main wash zone having a fluid inlet and a fluid outlet and the rinse zone having a fresh water fluid inlet, a soiled water fluid inlet, a recirculation inlet, and a recirculation outlet. A recirculation line is coupled to the recirculation inlet and recirculation outlet. The recirculation line is configured to receive a portion of water one or more zones, and includes an integrated fluid sanitizer module configured to at least partially sanitize the portion of the water from the rinse zone before it is returned to at least one zone.

### RELATED APPLICATIONS

The present application claims priority to U.S. Provisional Patent Application Ser. No. 63/515,040 filed on Jul. 21, 2023, the entirety of which is incorporated herein by reference.

### FIELD OF THE INVENTION

The present invention relates generally to processes and apparatuses for disinfectant textiles.

### BACKGROUND OF THE INVENTION

In industrial laundry applications, tunnel washing systems are often used to clean large volumes of soiled laundry (e.g., clothes, linens, fabrics, or the like). Typically, soiled laundry is placed into a loading hopper of a wash tunnel and is then moved through a series of zones or cycles, including a pre-wash zone, a main wash zone, and a rinse zone. After the laundry exits the rinse zone, a press then removes excess water from the laundry prior to moving the laundry to a dryer. Within each zone, chemicals and fresh water (collectively, “wash water”) is added to perform a desired cleaning operation. As the wash water flows through each zone and contacts the soiled laundry, the wash water may be contaminated by bacteria, viruses, algae, mold, fungi, or the like from the soiled laundry. As a result, soiled wash water is then removed from each zone via a drain and exits the system as waste. In an effort to reduce waste water, soiled wash water can be recirculated within the washing system.

In order to reduce or remove the bacteria, viruses, algae, mold, fungi, or the like in the soiled wash water. Current solutions only treat the soiled wash water going into the rinse zone. With so many variables and variations in water contaminants, these conventional solutions may not always perform as expected, and would struggle to keep up with demand.

Therefore, there is a need for processes and devices which address these drawbacks.

### SUMMARY OF THE PRESENT INVENTION

The present invention provides processes and apparatuses for washing textiles which address one or more of these drawbacks.

In general, in one or more aspects, an initial treatment of both fresh water and soiled water with a fluid sanitizer is provided to create an initial charge of the water containing, ozone, hydroxyl radicals, peroxide and other oxidizing substances. This initially cleans and disinfects the water and prepares it for use in the rinse zone. The oxidizer will dissipate quickly, with a half-life ranging from 15 seconds to 2 minutes, depending on temperature and pH. In the present invention, water is withdrawn from the rinse zone, passed to a fluid sanitizer where it may be treated, then injected back into the rinse zone during the entire wash process. This will allow the process and device to obtain and maintain ideal or desired conditions for washing and disinfecting the textiles. Further, this increases the oxidation reduction potential (ORP) to a range between 400 to 700 (or higher) mv which will disinfect and whiten the textiles. The ORP in the rinse zone in a conventional process typically is about 200 mv.

Accordingly, in an aspect of the present invention, the present invention may be generally characterized as providing a tunnel washing system having: a housing including a main wash zone, and a rinse zone, the main wash zone having a fluid inlet and a fluid outlet and the rinse zone having a fresh water fluid inlet, a soiled water fluid inlet, a recirculation inlet, and a recirculation outlet; and, a recirculation line coupled to recirculation inlet and recirculation outlet, the recirculation line configured to receive a portion of water from one or more zones of the tunnel washing system, the recirculation line including an integrated fluid sanitizer module configured to at least partially sanitize the portion of the water from the one or more zones.

The recirculation line may further comprise a pump.

The fresh water fluid inlet may be configured to receive fresh water and a fluid sanitizer. The fluid sanitizer may be selected from a group consisting of ozone, hydroxyl radicals, peroxide, and mixtures thereof.

The soiled water fluid inlet may be configured to receive soiled water and a fluid sanitizer. The fluid sanitizer may selected from a group consisting of ozone, hydroxyl radicals, peroxide, and mixtures thereof.

The integrated fluid sanitizer module may be an oxidative gas generator configured to deliver a volume of o-zone gas, wherein the volume of o-zone gas reacts with the portion of water from the rinse zone received by the recirculation line to produce peroxone, hydroxyl radicals, or both. The oxidative gas generator may include an ultra-violet (“UV”) lamp configured to emit a wavelength of light to react with ambient air and produce the volume of o-zone gas. The integrated fluid sanitizer module may include a germicidal ultra-violet (“UV”) lamp configured to emit a sanitizing wavelength of light to aid in sanitizing the portion of water from the one or more zones received by the recirculation line.

In a further another aspect, the present invention may be characterized, generally, as providing a process for disinfectant textiles by: washing textiles in a main wash zone of a tunnel washer, disinfecting the textiles in a rinse zone, passing a fresh water to the rinse zone, passing a soiled water to the rinse zone, removing, via a recirculation outlet, a portion of water from one or more zones of the tunnel washer, sanitizing, in an integrated fluid sanitizer module, the portion of the water from the one or more zones to provide sanitized recirculated water, and, returning, via a recirculation inlet, the sanitized recirculated water into at least one zone of the tunnel washer.

The process may further include mixing the fresh water with a fluid sanitizer for passing the fresh water to the rinse zone. The fluid sanitizer may be selected from a group consisting of ozone, hydroxyl radicals, peroxide, and mixtures thereof.

The process may further include mixing the soiled water with a fluid sanitizer before passing the soiled water to the rinse zone. The fluid sanitizer may be selected from a group consisting of ozone, hydroxyl radicals, peroxide, and mixtures thereof.

The process may further include maintaining a ORP in the rinse zone to be between 400 to 700 mv. For example, the process may include monitoring the ORP in the rinse zone.

The integrated fluid sanitizer module may include an oxidative gas generator configured to deliver a volume of o-zone gas, wherein the volume of o-zone gas reacts with the portion of water from the one or more zones received by the recirculation line to produce peroxone, hydroxyl radicals, or both. The oxidative gas generator may include an ultra-violet (“UV”) lamp configured to emit a wavelength of light to react with ambient air and produce the volume of o-zone gas. The integrated fluid sanitizer module may include a germicidal ultra-violet (“UV”) lamp configured to emit a sanitizing wavelength of light to aid in sanitizing the portion of water from the one or more zones received by the recirculation line.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The attached drawings will make it possible to understand how the invention can be produced and practiced, in which:

FIG. 1 is a schematic drawing of a tunnel washer according to one or more aspects of the present invention;

FIG. 2 is a schematic drawing of the rinse zone of a tunnel washer according to one or more aspects of the present invention; and,

FIG. 3 is a partial cross-sectional view of an integrated fluid sanitizer module of according to one or more aspects of the present invention.

### DETAILED DESCRIPTION OF THE PREFERRED EMBODIMENTS

As mentioned above, a processes and apparatuses for washing textiles have been invented which includes a fluid sanitizer on a recirculation line in a rinse zone of a rinse zone of a tunnel washer.

Accordingly, with reference the attached drawings, one or more embodiments of the present invention will now be described with the understanding that the described embodiments are merely preferred and are not intended to be limiting.

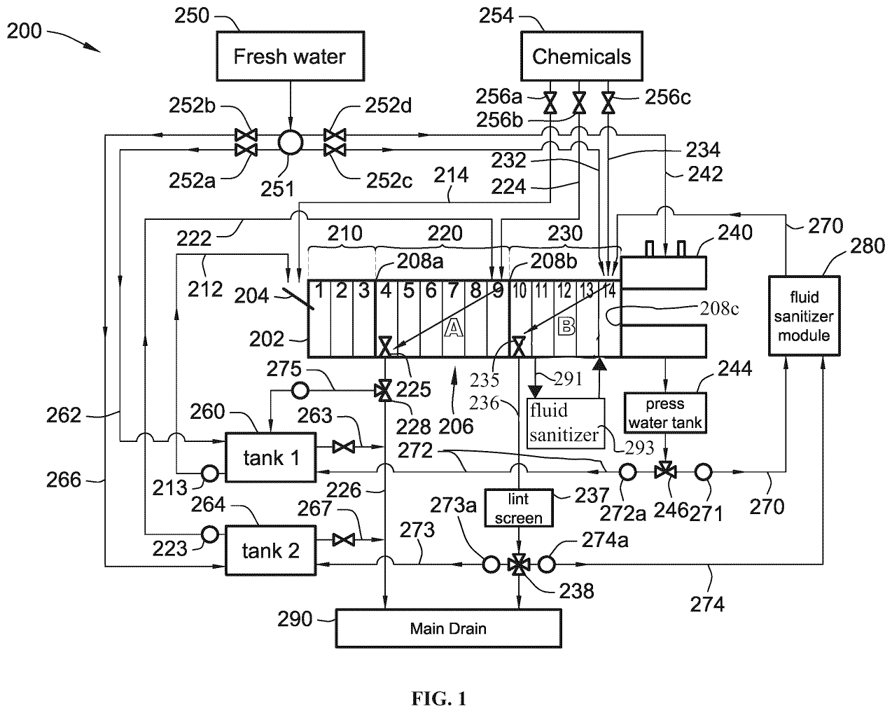

With reference to FIG. 1, a tunnel washing system 200 includes a wash tunnel 202, a press 240, a fresh water reservoir 250, a chemical reservoir 254, a first tank 260, a second tank 264, a first recirculation line 270, a second recirculation line 272, a third recirculation line 273, an optional fourth recirculation line 274, an optional fifth recirculation line 275, and a sixth recirculation line 291. The tunnel washing system 200 is generally used to efficiently clean large volumes of soiled laundry.

The wash tunnel 202 includes a loading hopper 204, a helix that defines a plurality of modules 206 forming a housing 211, a first seal 208a, a second seal 208b, and a third seal 208c. The helix is disposed within the wash tunnel 202 and has a helix/cork-screw shape which defines the plurality of modules 206. The first seal 208a, the second seal 208b, and the third seal 208c are positioned within the wash tunnel 202 such that the first seal 208a defines a pre-wash zone 210, the first seal 208a and the second seal 208b define a main wash zone 220, and the second seal 208b and the third seal 208c define a rinse zone 230. As depicted, the pre-wash zone 210 is formed by modules 1, 2, and 3 of the plurality of modules 206, the main wash zone 220 is formed by modules 4, 5, 6, 7, 8, and 9 of the plurality of modules 206, and the rinse zone 230 is formed by modules 10, 11, 12, 13, and 14 of the plurality of modules 206.

Each of the plurality of modules 206 includes perforations (not shown) to permit fluid to flow between adjacent modules within the pre-wash zone 210, the main wash zone 220, and the rinse zone 230 (e.g., between module 1 and module 2). The seals 208a, 208b, and 208c inhibit fluid from freely flowing between adjacent modules of the plurality of modules 206 (e.g., between module 9 and module 10). More specifically, the first seal 208a inhibits fluid flow between the pre-wash zone 210 and the main wash zone 220, the second seal 208b inhibits fluid flow between the main wash zone 220 and the rinse zone 230, and the third seal 208c inhibits fluid flow between the rinse zone 230 and the press 240. As a result, fluid flows through the plurality of modules 206 along arrow A in the main wash zone 220, and fluid flows through the plurality of modules 206 along arrow B in the rinse zone 230.

To operate the tunnel washing system 200, soiled laundry is placed into the wash tunnel 202 through the loading hopper 204 and falls into module 1 of the plurality of modules 206 in the pre-wash zone 210. The helix oscillates back and forth within the wash tunnel 202 along a central axis to agitate the soiled laundry within the first module for a predetermined period (e.g., between about one minute and about two minutes). After the predetermined period, the helix rotates a full revolution about its central axis, and the soiled laundry is exchanged from module 1 to module 2 of the plurality of modules 206 through a generally central throughhole of the helix. In this manner, the soiled laundry moves through the plurality of modules 206 of the wash tunnel 202 towards the press 240.

While the plurality of modules 206 of the wash tunnel 202 is shown as having fourteen modules, the plurality of modules 206 can have any number of modules based on the geometry of the helix (e.g., three modules, ten modules, twenty modules, thirty modules, etc.). While not shown, the wash tunnel 202 can also include a finish zone positioned between the third seal 208 c and the press 240. The finish zone is generally used to administer a final treatment of water/chemicals to the laundry prior to entering the press 240, and may by formed by, for example, two modules of the plurality of modules 206.

A freshwater reservoir, or tank, 250 contains fresh water, typically provided from a local source. A fresh water pump 251 may be provided along with a first fresh water valve 252a, a second fresh water valve 252b, a third fresh water valve 252c, a fourth fresh water valve 252d. The fresh water pump 251 pumps fresh water from the fresh water reservoir 250 towards the fresh water valves 252a, 252b, 252c, and 252d. A chemical reservoir 254 is also provided for storing chemicals utilized during the wash process. A first chemical valve 256a, a second chemical valve 256b, and a third chemical valve 256c are provided in lines. A pump (not shown) that may be the same as, or similar to, the fresh water pump 251 may be utilized to distribute the chemicals from the chemical reservoir 254.

The first tank 260 includes a first tank feed line 262 that is coupled to the first fresh water valve 252a and a first overflow line 263. The first tank feed line 262 delivers fresh water from the fresh water reservoir 250 to the first tank 260 for storage therein. The fresh water pump 251 and the first fresh water valve 252a control the volume of fresh water that flows into the first tank 260 through the first tank feed line 262. Similarly, the second tank 264, which is the same as, or similar to, the first tank 260, includes a second tank feed line 266 that is the same as, or similar to, the first tank feed line 262 and is coupled to the second fresh water valve 252b. The second tank 264 also includes a second overflow line 267. The first tank feed line 262 and the second tank feed line 266 can be a metal pipe, a PVC pipe, a hose, or the like, or any combination thereof.

The pre-wash zone 210 of the wash tunnel 202 includes a pre-wash feed line 212 and a pre-wash chemical feed line 214. The pre-wash feed line 212 is coupled to the first tank 260 and includes a pump 213. The pump 213 pumps fluid stored in the first tank 260 (e.g., fresh water delivered by the first tank feed line 262 described above) through the pre-wash feed line 212 and into the pre-wash zone 210 (e.g., into the loading hopper 204 and/or module 1). The pre-wash chemical feed line 214 is coupled to the first chemical valve 256a of the chemical reservoir 254 and delivers chemicals to the pre-wash zone 210 (e.g., into the loading hopper 204 and/or module 1). The chemicals delivered by the pre-wash chemical feed line 214 and the fluid delivered by the pre-wash feed line 212 mix to form pre-wash water that is then used in the pre-wash zone 210.

The main wash zone 220 of the wash tunnel 202 includes a main wash feed line 222 and a wash chemical feed line 224. The main wash feed line 222 is coupled to the second tank 264 and includes a pump 223. The pump 223 pumps fluid stored in the second tank 264 (e.g., fresh water delivered by the second tank feed line 266 described above) through the main wash feed line 222 and into the main wash zone 220 (e.g., into module 9). The wash chemical feed line 224 is coupled to the second chemical valve 256b of the chemical reservoir 254 and delivers chemicals into the pre-wash zone 210 (e.g., into module 9). The chemicals delivered by the wash chemical feed line 224 and the fluid delivered by the main wash feed line 222 mix to form wash water that is then used in the main wash zone 220.

As will be discussed in more detail below, the rinse zone 230 of the wash tunnel 202 includes a fresh water feed line 232 and a rinse chemical feed line 234. The fresh water feed line 232 is coupled to the third fresh water valve 252c of the fresh water reservoir 250 and delivers fresh water from the fresh water reservoir 250 to the rinse zone 230 (e.g., into module 14). The rinse chemical feed line 234 is coupled to the third chemical valve 256c of the chemical reservoir 254 and delivers chemicals into the rinse zone 230 (e.g., into module 14). The chemicals delivered by the rinse chemical feed line 234 and the fresh water delivered by the fresh water feed line 232 mix to form rinse water that is then used in the rinse zone 230.

As shown, the press 240 is positioned directly adjacent to the rinse zone 230 and includes a press water feed line 242 and a press water tank 244. Laundry exits the rinse zone 230 of the wash tunnel 202 and enters the press 240. The press 240 is generally used to remove excess rinse water from the laundry prior to transporting the laundry to a dryer. The press 240 removes excess water by compressing or squeezing the laundry to expel excess water (“soiled press water”) using hydraulic mechanisms or the like. The press water feed line 242 is coupled to the fourth fresh water valve 252d of the fresh water reservoir 250 and delivers fresh water from the fresh water reservoir 250 to the press 240. The press water tank 244 receives and stores the soiled press water and includes a press water diversion valve 246.

The first recirculation line 270 is coupled to the press water diversion valve 246 and includes a pump 270a and an integrated fluid sanitizer module 280. The first recirculation line 270 receives a portion of the soiled press water from the press water tank 244 via the press water diversion valve 246. The integrated fluid sanitizer module 280, discussed in more detail below, is used to at least partially sanitize the portion of the soiled press water received by the first recirculation line 270. The pump 270a pumps the portion of the soiled press water through the first recirculation line 270 and the integrated fluid sanitizer module 280 to the rinse zone 230 (e.g., as shown, into module 14). The first recirculation line 270 can be a metal pipe, a PVC pipe, a hose, or the like, or any combination thereof. In some implementations, the first recirculation line 270 includes a storage tank (not shown).

The second recirculation line 272 is similar to the first recirculation line 270 in that it is coupled to the press water diversion valve 246 and includes a pump 272a. The second recirculation line 272 receives a second portion of the soiled press water from the press water tank 244 via the press water diversion valve 246. The second recirculation line 272 differs from the first recirculation line in that it is coupled to the first tank 260, and the pump 272a pumps the second portion of the soiled press through the second recirculation line 272 to the first tank 260. The second portion of the soiled press water mixes with the fresh water delivered to the first tank 260 via the first tank feed line 262. As described above, the pre-wash feed line 212 delivers fluid from the first tank 260 to the pre-wash zone 210, meaning that at least some of the second portion of the soiled press water received by the first tank 260 is delivered to the pre-wash zone 210 via the pre-wash feed line 212.

Like the first recirculation line 270, the second recirculation line 272 can be a metal pipe, a PVC pipe, a hose, or the like, or any combination thereof. While not shown, in some implementations, the second recirculation line 272 can include a second integrated fluid sanitizer module 270 that is the same as or similar to the integrated fluid sanitizer module 280 of the first recirculation line. In other implementations, the press tank can include an integrated fluid sanitizer module that is the same as or similar to the integrated fluid sanitizer module 280 that sanitizes the press water prior to being delivered to the first recirculation line 270 and/or second recirculation line 272.

The press water diversion valve 246 controls amount of soiled press water that flows into either the first recirculation line 270 or the second recirculation line 272. For example, desirably, the press water diversion valve 246 diverts about thirty percent to about fifty percent of the soiled press water from the press water tank 244 to the first recirculation line 270 and about seventy percent to about thirty percent of the soiled press water from the press water tank 244 to the second recirculation line 272. Diverting about thirty percent to about fifty percent of the soiled press water to the first recirculation line 270 helps prevent the first tank 260 from overflowing due to the second recirculation line 272.

As described above, the rinse zone 230 uses at least rinse water which comprises fresh water received via the freshwater feed line 232 and chemicals received via the rinse chemical feed line 234. As shown in FIG. 1 and described above, the rinse water generally flows between module 14 and module 10 along arrow B. The rinse zone 230 includes a rinse water drain 235 (often referred to as a “weir box”) to control the rinse water level in the rinse zone 230 and to drain soiled rinse water that has been contaminated by the laundry (e.g., rinse water that has flowed from module 14 to module 10). The rinse water drain 235 is coupled to a rinse drain line 236 that receives the soiled rinse water. The rinse drain line 236 includes a lint screen 237 and a rinse water diversion valve 238. As shown, the lint screen 237 is integral with the rinse drain line 236 and is positioned upstream of the rinse water diversion valve 238. The lint screen 237 removes lint that has accumulated in the soiled rinse water from the laundry. The rinse drain line 236 continues past the rinse water diversion valve 238 and is coupled to a main drain 290 (e.g., a sewage line).

The third recirculation line 273 is coupled to the rinse water diversion valve 238 and includes a pump 273a. The third recirculation line 273 receives a portion of the soiled rinse water from the rinse drain line 236 via the rinse water diversion valve 238. The third recirculation line 273 is also coupled to the second tank 264, and the pump 273a pumps the portion of the soiled rinse water through the third recirculation line 273 to the second tank 264. The portion of the soiled rinse water then mixes with the fresh water delivered to the second tank 264 via the second tank feed line 266. As described above, the main wash feed line 222 delivers fluid from the second tank 264 to the main wash zone 220. As a result, at least some of the portion of the soiled rinse water received by the second tank 264 is delivered to the main wash zone 220 via the main wash feed line 222.

The third recirculation line 273 is the same as or similar to the first and second recirculation lines 270, 272 in that the third recirculation line 273 can be a metal pipe, a PVC pipe, a hose, or the like, or any combination thereof, and can include an integrated fluid sanitizer module (not shown) that is the same as or similar to the integrated fluid sanitizer module 280. Alternatively, the rinse drain line 236 can include an integrated fluid sanitizer module that is the same as or similar to the integrated fluid sanitizer module 280 and sanitizes the soiled rinse water upstream of the rinse water diversion valve 238.

In some implementations, the tunnel washing system 200 includes the optional fourth recirculation line 274, which is coupled to the rinse water diversion valve 238 and includes a pump 274a. The optional fourth recirculation line 274 is similar to the third recirculation line 273 in that it is coupled to the rinse water diversion valve 238 and receives a second portion of the soiled rinse water from the rinse drain line 236. More specifically, in such implementations, the rinse water diversion valve 238 is a four-way valve that is used to control the respective volumes of the portion of the soiled rinse water received by the third recirculation line 273, the second portion of the soiled rinse water received by the optional fourth recirculation line 274, and a third portion of the soiled rinse water received by the main drain 290. As shown, the optional fourth recirculation line 274 is connected to first recirculation line 270 so that second portion of the soiled rinse water flows through the integrated fluid sanitizer module 280 and is sanitized. As described above, the first recirculation line 270 delivers fluid from the integrated fluid sanitizer module 280, thus, in such implementations, the first recirculation line 270 delivers sanitized rinse water to the rinse zone 230 (e.g., into module 14). Alternatively, the optional fourth recirculation line 274 can include a fourth integrated fluid sanitizer module (not shown) that is the same as or similar to the integrated fluid sanitizer module 280, and the fourth recirculation line directly delivers sanitized rinse water to the rinse zone 230.

As described above, the main wash zone 220 uses wash water which comprises fluid from the first tank 260 received via the main wash feed line 222 and/or chemicals received via the wash chemical feed line 224. As shown in FIG. 1 and described above, the wash water generally flows between module 9 and module 4 along arrow A. The main wash zone 220 includes a wash water drain 225 (often referred to as a “weir box”) to control the wash water level in the main wash zone 220 and to drain soiled wash water (e.g., wash water that has flowed from module 9 to module 4 and has become contaminated by the soiled laundry). The wash water drain 225 is coupled to a wash water drain line 226 that receives the soiled wash water and has a wash water diversion valve 228. The wash water drain line 226 continues downstream of the wash water diversion valve 228 and is coupled to the main drain 290. As shown, the overflow line 263 of the first tank 260 and the overflow line 267 of the second tank 264 are coupled to the wash water drain line 226 downstream of the wash water diversion valve 228, permitting overflow from the first tank 260 and/or second tank 264 to spill into the main drain 290 and exit the system.

In some implementations, the tunnel washing system 200 includes an optional fifth recirculation line 275 that is coupled to the wash water diversion valve 228 and includes a pump 275a. The optional fifth recirculation line 275 is similar to the optional fourth recirculation line 274 in that it receives a second portion of the soiled wash water from the wash water drain line 226 via the wash water diversion valve 228. As shown, the optional fifth recirculation line 275 is coupled to the first tank 260, and the pump 275a pumps the second portion of the soiled wash water through the fifth recirculation line 275 and into the first tank 260. As described above, the pre-wash feed line 212 delivers fluid from the first tank 260 to the pre-wash zone 210, thus, in such implementations, the pre-wash feed line 212 delivers at least a some of the second portion of soiled wash water stored in the first tank 260 to the pre-wash zone 210.

In some implementations, the optional fifth recirculation line 275 can include an integrated fluid sanitizer that is the same as or similar to the integrated fluid sanitizer module 280 of the first recirculation line 270 to sanitize the soiled wash water prior delivering it to the first tank 260. Further the fifth recirculation line 275 can be coupled to the pre-wash zone 210 (e.g., via the loading hopper 204) to directly deliver soiled wash water to the pre-wash zone 210.

According to the various embodiments, a sixth recirculation line 291 is provided. The sixth recirculation line 291 can be a metal pipe, a PVC pipe, a hose, or the like, or any combination thereof. The sixth recirculation line 291 is used to remove water from the rinse zone 230, sanitize it in an integrated fluid sanitizer 293, and then return the sanitized water to the rinse zone 230 to provide for an increased ORP level.

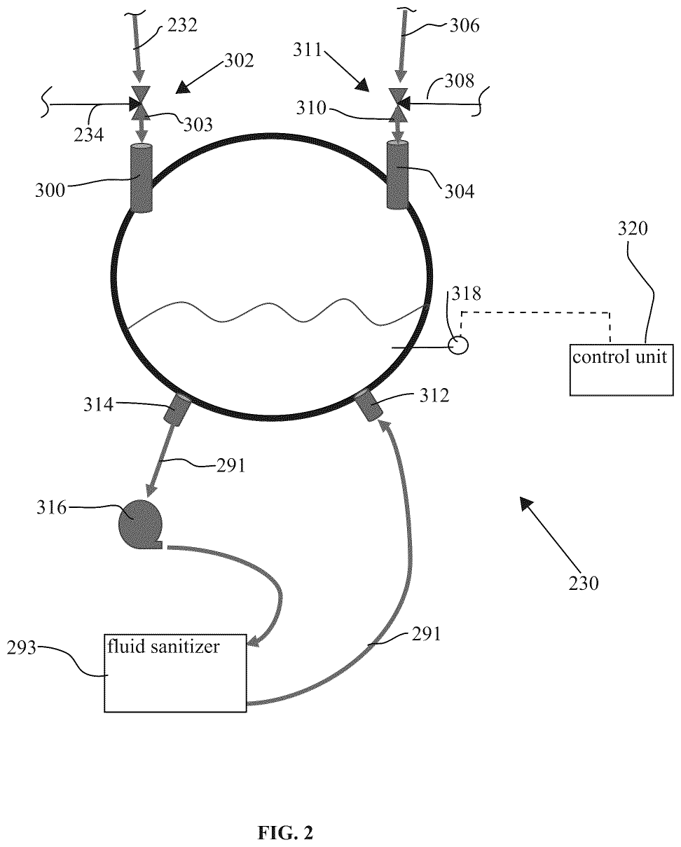

As shown in FIG. 2, the rinse zone 230 includes a fresh water inlet 300 which receives the fresh water via line 232 which may be mixed with a fluid sanitizer from line 234 that may passed into a fresh water manifold 302 which may include a valve 303. The fluid sanitizer may be selected from a group consisting of ozone, hydroxyl radicals, peroxide, and mixtures thereof.

The rinse zone 230 also includes a soiled water fluid inlet 304 which receives a soiled water in line 306 which is mixed with a fluid sanitizer from line 308 that may passed into a soiled water manifold 310 which may include a valve 311. Again, the fluid sanitizer may be selected from a group consisting of ozone, hydroxyl radicals, peroxide, and mixtures thereof.

According to the present invention, the rinse zone 230 further includes a recirculation inlet 312, a recirculation outlet 314, with the sixth recirculation line 291 coupled to recirculation inlet 312 and recirculation outlet 314. A pump 316 may be utilized to control the removal of the water from the rinse zone 230.

The sixth recirculation line 291 is configured to remove a portion of water from the rinse zone 230 and pass it to the integrated fluid sanitizer module 293. The integrated fluid sanitizer module 293 is configured to at least partially sanitize the portion of the water from the rinse zone 230, so that the treated water (with an increased ORP level) may be returned to the rinse zone 230.

A sensor 318 may be provided to measure an ORP level in the rinse zone 230. The measured ORP level may be compared, by a control unit 320, against a predetermined value or a desired value. For example, the predetermined or a desired ORP level may be between 400 to 700 (or even higher) mv.

Depending on the comparison, the control unit 320 may send signals to one or more components, such as pump, valves, sanitizer modules in order to adjust process conditions so that the ORP level in the rinse zone 320 approaches the predetermined value or desired value. For example, the control unit 320 may send signals to one or more of the valve 303 of the fresh water manifold 302, the valve 311 of the soiled water manifold 310, the pump 316 in the sixth recirculation line 291, and the fluid sanitizer 293.

The measured ORP level may be entered into the control unit 320 or may be determined based on a look up table of stored values. Accordingly, while conventional processes and devices have an ORP level of approximately 200 mv in the rinse zone 230, the present invention allows the ORP level to adjust and accommodate various variable and variations in the water and/or textiles.

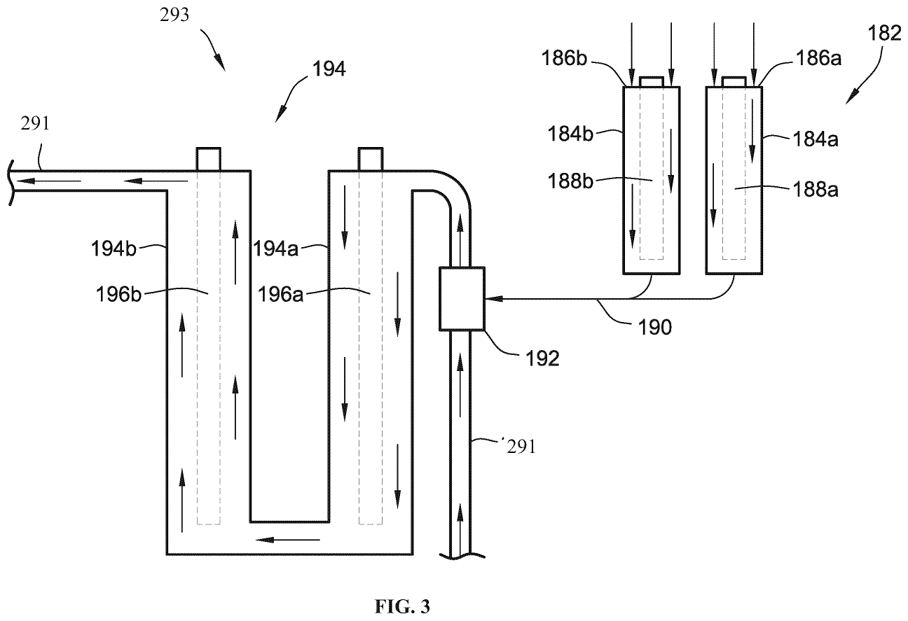

Turning to FIG. 3, the integrated fluid sanitizer module 293, which may be any of the fluid sanitizer modules described herein, is shown.

The depicted integrated fluid sanitizer module 293 includes an oxidative gas generator 182, a manifold 192, and a counter-flow mixer 194. The oxidative gas generator 182 is used to produce a volume of o-zone gas and includes a first lamp housing 184a and a second lamp housing 184b. The first lamp housing 184a includes a first gas inlet 186a and a first ultra-violet (“UV”) lamp 188a disposed therein. Similarly, the second lamp housing 184b includes a second gas inlet 186b and a second UV lamp 188b disposed therein. The first and second gas inlets 186a, 186b permit ambient air to enter each of the respective lamp housings 184a, 184b and to flow past each respective UV lamp 188a, 188b. When powered by a power source (not shown), the first and second UV lamps 188a, 188b emit a wavelength of light between about 100 nm and about 500 nm.

When ambient air enters the first gas inlet 186a and the second gas inlet 186b and flows past the first UV lamp 188a and the second UV lamp 188b while both are emitting a wavelength of light of between about 180 nm and about 260 nm (e.g., about 187 nm), the wavelength of light breaks down oxygen molecules (O₂) from the ambient air into oxygen atoms (O). These oxygen atoms then react with other oxygen (O₂) molecules in the ambient air to produce the volume of o-zone gas (O₃ molecules). O-zone is a pale blue gas with a distinctively pungent smell and is a powerful disinfectant, oxidant, and deodorizer.

In some embodiments, the oxidative gas generator 182 can include an optional fan (not shown) to aid in forcing ambient air through the gas inlet 186 to produce the volume of o-zone gas. While the oxidative gas generator 182 is shown as having two lamp housings 184a and 184b and two UV lamps 188a and 188b, the oxidative gas generator 182 can include any number of lamp housings and/or UV lamps (e.g., one UV lamp, four UV lamps, etc.).

In some implementations, the integrated fluid sanitizer module 293 includes an oxidative gas generator that does not include a UV lamp and produces the volume of o-zone gas using any other suitable mechanism (e.g., corona discharge). Alternatively, the integrated fluid sanitizer module 293 can include an o-zone gas storage tank (not shown) filled with o-zone gas and/or an oxygen storage tank (not shown) filled with oxygen gas. In such implementations, the oxygen storage tank can be used in conjunction with the oxidative gas generator 182 described above to deliver oxygen gas through the first and second gas inlets 186a, 186b to increase the production of o-zone gas.

Once produced by the oxidative gas generator 182, the volume of o-zone is delivered to the manifold 192 via a gas delivery line 190. The gas delivery line 190 can be a metal pipe, a PVC pipe, a hose, or the like, or any combination thereof. The manifold 192 can be a venturi injector (with or without a bypass manifold), a mixing valve, a diffuser, an aeration system, or the like, or any combination thereof. When the volume of o-zone gas reaches the manifold 192, the volume of o-zone gas is mixed with and at least partially sanitizes the soiled wash water in the recirculation line 170 as it flows through the manifold 192.

O-zone gas sanitizes by killing and/or inactivating microorganisms (e.g., bacteria, viruses, algae, mold, fungi, or the like), and can be many times more effective than chemicals. For example, o-zone gas can be approximately 150% more effective than chlorine and reacts over 3,000 times faster. O-zone gas is also advantageous because its chemical reactions do not leave any harmful byproducts. Because of its high oxidation potential, o-zone gas can precipitate a variety of organic and inorganic contaminates, including, for example, iron, manganese, sulfides, metals, body oils, sweat, and saliva. Further, o-zone gas oxidizes organic chemicals that are responsible for producing undesirable odors.

Advanced oxidative processes (often referred to as “AOPs”) are a set of chemical treatment procedures designed to remove organic and/or inorganic materials in water using hydroxyl radicals (*OH). Generally, the chemistry in AOPs can be divided into three parts: (1) formation of hydroxyl radicals, (2) initial attacks by the hydroxyl radicals on target molecules, breaking the target molecules into fragments, and (3) subsequent attacks by hydroxyl radicals until ultimate mineralization. One subset of AOP chemical processes that produce hydroxyl radicals employs o-zone gas. First, o-zone gas (03) reacts with a hydroxyl ion (HO—) to yield HO₂— and O₂ (oxygen). Next, a second o-zone molecule (O₃) reacts with the HO₂— produced in the previous step to yield HO₂ and O₃— (an ozonide radical). The ozonide radical (O₃—) then reacts with H+ to yield HO₃—. Finally, the HO₃— produced during the previous step yields a hydrogen radical (*OH) and an oxygen molecule (O₂) upon protonation.

The hydroxyl radical is often referred to as the “detergent” of the troposphere because it reacts with many pollutants, decomposing them through “cracking”, often acting as the first step to their removal. It also has an important role in eliminating some greenhouse gases like methane and ozone. The rate of reaction with the hydroxyl radical often determines how long many pollutants last in the atmosphere, if they do not undergo photolysis or are rained out. For instance, methane, which reacts relatively slowly with hydroxyl radical, has an average lifetime of less than five years, and many CFCs have lifetimes of 50 years or more. Pollutants, such as larger hydrocarbons, can have very short average lifetimes of less than a few hours. The hydroxyl radicals first reaction with many volatile organic compounds (often referred to as “VOCs”) having a chemical formula of RH, is the removal of a hydrogen atom, forming water (H₂O) and an alkyl radical (R*). The alkyl radical will typically react rapidly with oxygen (O₂) forming a peroxy radical (RO*2). The fate of this radical in the troposphere is dependent on factors such as the amount of sunlight, pollution in the atmosphere and the nature of the alkyl radical that formed it.

AOPs that form hydroxyl radicals are advantageous in the field of water treatment for a number of reasons. For example, hydroxyl radicals can effectively eliminate organic compounds in aqueous phase, rather than collecting or transferred pollutants into another phase. Due to the high reactivity of hydroxyl radicals, they react with almost every aqueous pollutant without discriminating, thereby allowing many organic contaminates to be removed at the same time. Hydroxyl radicals can also remove some heavy metals in the form of precipitated M(OH)ₓ. Because the complete reduction product of hydroxyl radicals is H₂O, AOPs do not introduce any new hazardous substances into the water.

As shown in FIG. 3, the counter-flow mixer 194 of the integral fluid sanitizer module 293 is positioned downstream of the manifold 192. The counter-flow mixer 194 includes a first portion 194a and a second portion 194b positioned downstream of the first portion 194a. Due to this geometry, water which for illustrative purposes is in the sixth recirculation line 291, flows into the first portion 194a and then into the second portion 194b. The first portion 194a includes a first sanitizing lamp 196a disposed therein and the second portion 194b includes a second sanitizing lamp 196b disposed therein. When powered by a power source (not shown), the first sanitizing lamp 196a emits a first sanitizing wavelength of light and the second sanitizing lamp 196b emits a second sanitizing wavelength of light. These sanitizing wavelengths of light kill and/or inactivate microorganisms and can range between about 10 nm and about 400 nm. Preferably, the first and second sanitizing wavelengths of light are about 254 nm, which is commonly referred to as “germicidal ultra-violet light”.

As water enters the first portion 194a of the counter-flow mixer 194, the water flows past the first sanitizing lamp 196a. The first sanitizing wavelength of light emitted by the first sanitizing lamp 196a sanitizes the water by killing and/or inactivating microorganisms and reacts with the volume of o-zone gas injected in the manifold 192 to convert O₃ molecules into hydroxyl radicals. The water then flows from the first portion 194a into the second portion 194b and flows past the second sanitizing lamp 196b. Like the first sanitizing wavelength of light, the second sanitizing wavelength of light emitted by the second sanitizing lamp 196b sanitizes the water and produces hydroxyl radicals by reacting with O₃ molecules. The geometry and flow pattern of the counter-flow mixer 194 causes press changes and turbulence in the water to increase the chemical reactions between the o-zone gas, the water, and the sanitizing wavelengths of light emitted by the first and second sanitizing lamps 196a, 196b. Sanitized or treated water then exits the second portion 194b of the counter-flow mixer 194 and continues along the sixth recirculation line 291 towards the rinse zone 230 and the recirculation inlet 312 (FIG. 2).

While the counter-flow mixer 194 is shown and described herein as including a first sanitizing lamp 196a and a second sanitizing lamp 196b, the counter-flow mixer 194 can include any number of sanitizing lamps (e.g., one sanitizing lamp, four sanitizing lamps, ten sanitizing lamps, etc.). In some implementations, the integrated fluid sanitizer module 293 does not include a counter-flow mixer and instead includes one or more sanitizing lamps at least partially disposed within the sixth recirculation line 291.

In some implementations, the integrated fluid sanitizer module 293 includes a chemical feed line (not shown) that is coupled to the chemical reservoir or tank 254 (FIG. 1. The chemical feed line delivers chemicals into the sixth recirculation line 291 to further aid in sanitizing the water from the rinse zone 230. The chemical feed line of the integrated fluid sanitizer module 293 can include one or more pumps (not shown) and/or valves (not shown) to control the flow of chemicals into the sixth recirculation line 291. For example, the chemical feed line can deliver hydrogen peroxide into the sixth recirculation line 291 (e.g., upstream of the manifold 192 and/or the counter-flow mixer 194). Hydrogen peroxide, which has a chemical formula of H₂O₂, is the simplest peroxide (i.e., a compound with an oxygen-oxygen single bond) and is often used as a weak oxidizer, bleaching agent, and disinfectant. For safety reasons, hydrogen peroxide is often handled as a dilute solution, rather than in its pure form.

In addition to producing hydroxyl radicals using o-zone gas, AOPs can employ hydrogen peroxide and ultra-violet light to produce hydroxyl radicals. When exposed to a wavelength of ultra-violet light (e.g., light having a wavelength between about 150 nm and about 250 nm), hydrogen peroxide yields hydroxyl radicals, which as described above, act as a sanitizing agent. Specifically, the ultra-violet wavelength of light causes hemolytic bond cleavage of the oxygen bond of one H₂O₂, molecule, resulting in the formation of two hydroxyl radicals. In this manner, injecting hydrogen peroxide into the sixth recirculation line 291 such that it is exposed to the sanitizing wavelengths of light of the first and second sanitizing lamps 196a, 196b can force an AOP and produce hydroxyl radicals. Further, as described above, hydrogen peroxide is one of the chemicals that can be used in the one or more wash cycles (e.g., during the main wash cycle 120) as a bleaching agent and/or disinfectant. Thus, hydrogen peroxide may already be present in the soiled wash water in the sixth recirculation line 291.

Accordingly, by withdrawing water from the rinse zone, passing it to a fluid sanitizer where it may be treated, then injecting it back into the rinse zone during the wash process, the present processes and devices allow for more ideal or desired conditions to be achieved and maintained.

The systems and devices described herein may include a controller or control unit or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of my contribution to the art.

Claimed is:

1. A tunnel washing system comprising:
a housing including a main wash zone, and a rinse zone, the main wash zone having a fluid inlet and a fluid outlet and the rinse zone having a fresh water fluid inlet, a soiled water fluid inlet, a recirculation inlet, and a recirculation outlet; and,
a recirculation line coupled to recirculation inlet and recirculation outlet, the recirculation line configured to receive a portion of water from one or more zones of the tunnel washing system, the recirculation line including an integrated fluid sanitizer module configured to at least partially sanitize the portion of the water from one or more zones.

2. The tunnel washing system of claim 1, wherein the recirculation line further comprises a pump.

3. The tunnel washing system of claim 1, wherein the fresh water fluid inlet is configured to receive fresh water and a fluid sanitizer.

4. The tunnel washing system of claim 3, wherein the fluid sanitizer is selected from a group consisting of ozone, hydroxyl radicals, peroxide, and mixtures thereof.

5. The tunnel washing system of claim 1, wherein the soiled water fluid inlet is configured to receive soiled water and a fluid sanitizer.

6. The tunnel washing system of claim 5, wherein the fluid sanitizer is selected from a group consisting of ozone, hydroxyl radicals, peroxide, and mixtures thereof.

7. The tunnel washing system of claim 1, wherein the integrated fluid sanitizer module includes an oxidative gas generator configured to deliver a volume of o-zone gas, wherein the volume of o-zone gas reacts with the portion of water from the rinse zone received by the recirculation line to produce peroxone, hydroxyl radicals, or both.

8. The tunnel washing system of claim 7, wherein the oxidative gas generator includes an ultra-violet (“UV”) lamp configured to emit a wavelength of light to react with ambient air and produce the volume of o-zone gas.

9. The tunnel washing system of claim 1, wherein the integrated fluid sanitizer module includes a germicidal ultra-violet (“UV”) lamp configured to emit a sanitizing wavelength of light to aid in sanitizing the portion of water from the one or more zones received by the recirculation line.

10. A process for disinfectant textiles, the process comprising:
washing textiles in a main wash zone of a tunnel washer,
disinfecting the textiles in a rinse zone,
passing a fresh water to the rinse zone,
passing a soiled water to the rinse zone,
removing, via a recirculation outlet, a portion of water from one or more zones of the tunnel washer,
sanitizing, in an integrated fluid sanitizer module, the portion of the water from the one or more zones to provide sanitized recirculated water, and,
returning, via a recirculation inlet, the sanitized recirculated water into at least one zone of the tunnel washer.

11. The process of claim 10 further comprising:
mixing the fresh water with a fluid sanitizer for passing the fresh water to the rinse zone.

12. The process of claim 11, wherein the fluid sanitizer is selected from a group consisting of ozone, hydroxyl radicals, peroxide, and mixtures thereof.

13. The process of claim 10 further comprising:
mixing the soiled water with a fluid sanitizer before passing the soiled water to the rinse zone.

14. The process of claim 13, wherein the fluid sanitizer is selected from a group consisting of ozone, hydroxyl radicals, peroxide, and mixtures thereof.

15. The process of claim 10, further comprising:
maintaining an ORP level in the rinse zone to be between 400 to 700 mv.

16. The process of claim 15, further comprising:
monitoring the ORP level in the rinse zone.

17. The process of claim 10, wherein the integrated fluid sanitizer module includes an oxidative gas generator configured to deliver a volume of o-zone gas, wherein the volume of o-zone gas reacts with the portion of water from the one or more zones received by the recirculation line to produce peroxone, hydroxyl radicals, or both.

18. The process of claim 17, wherein the oxidative gas generator includes an ultra-violet (“UV”) lamp configured to emit a wavelength of light to react with ambient air and produce the volume of o-zone gas.

19. The process of claim 10, wherein the integrated fluid sanitizer module includes a germicidal ultra-violet (“UV”) lamp configured to emit a sanitizing wavelength of light to aid in sanitizing the portion of water from the one or more zones received by the recirculation line.
